(19) United States
(12) Patent Application Publication
(10) Pub. No.: US 2014/0016052 A1
(43) Pub. Date: Jan. 16, 2014

(54) LIQUID CRYSTAL PANEL, DRIVING METHOD THEREOF, AND LIQUID CRYSTAL DISPLAY DEVICE CONTAINING THE SAME

(71) Applicant: InnoLux Corporation, Miao-Li County (TW)

(72) Inventors: Kei-Hsiung YANG, Miao-Li County (TW); Ruey-Jer WENG, Miao-Li County (TW)

(21) Appl. No.: 13/934,467

(22) Filed: Jul. 3, 2013

(30) Foreign Application Priority Data
Jul. 10, 2012 (TW) 101124763

(51) Int. Cl. G02F 1/133

(52) U.S. Cl. CPC G02F 1/13306
USPC 349/34

(57) ABSTRACT

A liquid crystal panel, a driving method thereof, and a liquid crystal display device containing the same are disclosed. The liquid crystal panel of the present invention comprises: a first substrate having a first electrode layer; a second substrate having a second electrode layer opposite to the first electrode layer; a blue-phase liquid crystal layer disposed between the first substrate and the second substrate; and a light-shielding region disposed on the second substrate. When a bias voltage is applied to the first electrode layer and the second electrode layer, a refractive gradient is formed in the blue-phase liquid crystal layer, and thereby an incident light passing through the blue-phase liquid crystal layer focuses on the light-shielding region.

### CROSS REFERENCE TO RELATED APPLICATION

This application claims the benefits of the Taiwan Patent Application Serial Number 101124763, filed on Jul. 10, 2012, the subject matter of which is incorporated herein by reference.

### BACKGROUND OF THE INVENTION

1. Field of the Invention

The disclosure relates to a liquid crystal panel, a driving method thereof, and a liquid crystal display device containing the same and, more particularly, to a liquid crystal panel using a blue-phase liquid crystal layer as a gradient refractive index lens, a driving method thereof, and a liquid crystal display device containing the same.

2. Description of Related Art

A liquid crystal display (LCD) is a flat panel display with a thin thickness, so a conventional cathode ray tube (CRT) display is gradually replaced by the LCD. Nowadays, the LCD becomes one of the most popular displays.

The LCD mainly comprises a liquid display panel and a backlight module disposed under the liquid display panel, i.e. under a side of a thin film transistor substrate (TFT substrate), wherein the backlight module can provide light to the liquid crystal panel. When pixels of the liquid crystal panel are controlled, it is possible to present images on the liquid crystal panel.

Currently, liquid crystal molecules used in the liquid crystal panel usually have extended rod-like structures, and the dipole induced by the liquid crystal molecules has strong dipole moment parallel to the long molecular axis thereof. Hence, when an external electric field is provided to the liquid crystal molecules, the liquid crystal molecules are rotated and exhibit different orientation orders. In addition, the conventional backlight is unpolarized light, so a polarizer has to be disposed on a side of the TFT substrate to change the unpolarized backlight into polarized light before the backlight propagates into the liquid crystal layer. The rotation of the liquid crystal molecules controls whether the polarized light propagating through the liquid crystal layer can pass through another polarizer disposed on a color filter substrate (CF substrate) or not, so the purpose of controlling a bright or dark state of the panel can be obtained.

However, during the process that light passes through the polarizers, more than 50% of the backlight may be absorbed by the polarizer disposed on the side of the TFT substrate, and thus most of the backlight is wasted.

Therefore, it is desirable to provide a liquid crystal panel and a liquid crystal display device containing the same, which can increase the utilization rate of the backlight and accomplish the purpose of low energy consuming.

### SUMMARY OF THE INVENTION

An object of the present invention is to provide a liquid crystal panel and a liquid crystal display device containing the same, which does not comprise a polarizer and thus the utilization rate of backlight can be improved.

Another object of the present invention is to provide a method for driving a liquid crystal panel, which can control the switch between bright states and dark states without using a polarizer.

To achieve the object, the liquid crystal panel of the present invention comprises: a first substrate having a first electrode layer; a second substrate having a second electrode layer opposite to the first electrode layer; a blue-phase liquid crystal layer disposed between the first substrate and the second substrate; and a light-shielding region disposed on the second substrate, wherein a bias voltage is provided to the first electrode layer and the second electrode layer to form a refractive gradient in the blue-phase liquid crystal layer, and an incident light passing through the blue-phase liquid crystal layer with the refractive gradient focuses on the light-shielding region. Herein, the first substrate is a thin-film transistor substrate (TFT substrate), and the second substrate is a color filter substrate (CF substrate).

More specifically, the first electrode layer and the second electrode layer respectively has a first surface and a second surface, and the first surface and the second surface correspond to each other. In addition, a distance between the first surface of the first electrode layer and the second surface of the second electrode layer in a first region is different from that in a second region. When a bias voltage is provided to the first electrode layer and the second electrode layer, a non-uniform electric field can be formed which can induce the birefringence of blue-phase liquid crystals changed, and thereby a refractive gradient in the blue-phase liquid crystal layer is formed.

In addition, the present also provide a method for driving the aforementioned liquid crystal panel, which comprises the following steps: (A) providing the aforementioned liquid crystal panel; and (B) providing a bias voltage to the first electrode layer and the second electrode layer to form a non-uniform electric field in the blue-phase liquid crystal layer, in which the non-uniform electric field can induce a refractive gradient formed in the blue phase liquid crystal layer and thereby an incident light passing through the blue-phase liquid crystal layer with the refractive gradient can focus on the light-shielding region.

In the liquid crystal panel and the method for driving the same of the present invention, when there is no bias voltage provided to the first electrode layer and the second electrode layer or the provided bias voltage is 0, the blue-phase liquid crystals in the blue-phase liquid crystal layer are isotropic, the refractive indices in the whole blue-phase liquid crystal layer are the same, and an effective refractive indices ellipsoid can be taken into circular. In this case, the incident light passing through the blue-phase liquid crystal layer is not deflected. Hence, when the incident light illuminating from the first substrate into the blue-phase liquid crystal layer, the isotropic blue-phase liquid crystals cannot make the incident light focus, and thereby the liquid crystal panel is present in a bright state.

On the other hand, when a bias voltage is provided to the first electrode layer and the second electrode layer, the magnitude difference between a vertical axis and a horizontal axis in the effective refractive indices ellipsoid is increased as the electric field increased. In addition, a longitude direction is parallel to the direction of the electric field. Hence, when a bias voltage is provided to the first electrode layer and the second electrode layer, a non-uniform electric field can be formed in the blue-phase liquid crystal layer due to the different distances between the first surface of the first electrode layer and the second surface of the second electrode layer at different regions of the blue-phase liquid crystal layer. This non-uniform electric field can change not only nₑ but also nₒ of the blue-phase liquid crystals, so that both the distributions of nₑ and nₒ thereof are formed into a gradient in the blue-phase liquid crystal layer. In this case, a gradient refractive index lens (GRIN Lens) formed by the blue-phase liquid crystal layer may cause the path of the incident light deflected and focused on the light-shielding region, and thereby the liquid crystal panel is present in a dark state.

In addition, the liquid crystal panel can be present in the bright and dark states as well as in a gray state by controlling the voltage applied to the first electrode layer and the second electrode layer to change the focusing levels of the incident light on the light-shielding region. Herein, the range of the provided voltage is not particularly limited, as long as the effect of controlling the bright and dark states can be obtained.

In the liquid crystal panel and the method for driving the same of the present invention, the refractive index of the blue-phase liquid crystal layer can be controlled by voltage, so the bright and dark states of the liquid crystal panel can be adjusted without using a polarizer. Hence, compared to the conventional liquid crystal panel, that of the present invention can improve the disadvantage that light is absorbed by a polarizer, and therefore the utilization rate of the backlight can be increased and the effect of energy saving can be accomplished.

In the liquid crystal panel and the method for driving the same of the present invention, the first electrode layer and the second electrode layer can be transparent electrodes. The transparent electrodes used in the present invention can be any transparent electrode generally used in the art. For example, the transparent electrodes can be any electrode made of transparent conductive oxide (TCO), such as ITO electrodes, or IZO electrodes. In addition, preferably, the first substrate and the second substrate are light-transmitting substrate, such as plastic substrates or glass substrates.

The shapes of the first electrode layer and the second electrode layer are not particularly limited, as long as a non-uniform electric field can be formed between the first electrode layer and the second electrode layer when a voltage is provided thereto. The first electrode layer can be a plate electrode and the second electrode layer can be a patterned electrode; and vice versa. Alternatively, both the first electrode layer and the second electrode layer are plate electrodes, but a resistance of the plate electrode in a first region is different from that in a second region. Preferably, the first electrode layer is a plate electrode, and the second electrode layer is a patterned electrode. In addition, the shape of the patterned electrode is not particularly limited, and can be a wavy electrode, a curved electrode, a stripe electrode, or an electrode with an opening. Preferably, the patterned electrode is an electrode with an opening, wherein the design of the opening is not particularly limited and can be a circle, a rectangle, a triangle, a trapezoid, a cross shape or a curved shape. Preferably, the opening is a circular opening.

In the liquid crystal panel and the method for driving the same of the present invention, the position of the light-shielding region is not particularly limited, as long as the incident light can focus thereon (i.e. focus position) when a voltage is provided to the electrodes. Examples of the position of the light-shielding region comprise: any surface of the second substrate, a position over the second substrate and at a predetermined distance therefrom, or a black matrix of a color filter disposed outside the opening of the second electrode layer, but the present invention is not limited thereto. Preferably, the light-shielding region is disposed on the second substrate and in the opening of the second electrode layer. More preferably, the light-shielding region is disposed in the opening of the second electrode layer and on a surface of the second substrate, wherein this surface faces to the first electrode layer.

In addition, the light-shielding layer can be a light-absorbing layer or a reflection layer. In the case that the light-shielding layer is a light-absorbing layer, it can absorb the light focusing thereon. In the case that the light-shielding layer is a reflection layer, the light focusing thereon can be reflected back to the backlight, so the utilization rate of the backlight can further be improved.

Furthermore, the blue-phase liquid crystals only exist over a small temperature range, so the blue-phase liquid crystal layer further comprises a polymer to stabilize the blue-phase liquid crystals to increase the temperature range that the blue phases of liquid crystals can exist.

In the liquid crystal panel and the method for driving the same of the present invention, the liquid crystal panel may further comprise a dielectric layer or a micro-lens array, which is disposed on the second electrode layer and faces to the first electrode layer. The dielectric layer or the micro-lens array can facilitate the light passing through the blue-phase liquid crystal layer focusing on the light-shielding region.

In order to decrease the reflection on the first electrode layer and the second electrode layer, the thicknesses of the first electrode layer and the second electrode layer are very important. When the electrode layer (i.e. the first electrode layer or the second electrode layer) is sandwiched between two materials, in which both materials have lower or higher refractive indices than that of an electrode material of the electrode layer; and more specifically, when the electrode layer is sandwiched between two materials having lower refractive indices than that of the electrode material or two materials having higher refractive indices than that of the electrode material, a thickness of the electrode layer is satisfied with the following equation (I). On the other hand, when the electrode layer is sandwiched between a first material and a second material, in which the first material has a lower refractive index than that of an electrode material of the electrode layer and the second material has a higher refractive index than that of the electrode material of the electrode layer, a thickness of the electrode layer is satisfied with the following equation (II).

Thickness of the electrode layer=(a wavelength of the incident light)/(2×the refractive index of the electrode material) (I)

Thickness of the electrode layer=(a wavelength of the incident light)/(4×the refractive index of the electrode material) (II)

Since users' eyes are more sensitive to light with wavelengths around those of green light, the design of the thickness of the electrode layer is preferably based on the range that the wavelengths of the incident light is closed to those of green light. Herein, the range of the wavelengths of the incident light can be from 460 nm to 620 nm; and preferably from 530 nm to 570 nm. More preferably, the wavelength of the incident light is about 550 nm, and especially a higher transmittance rate can be obtained to get better display effect as the range of the wavelengths of the incident light is more closed to 550 nm. An example that the electrode material is ITO with a refractive index of 1.9 and the incident light has a wavelength of 550 nm is provided. When the ITO electrode layer is sandwiched between two materials having lower refractive indices than that of ITO or two materials having higher refractive indices than that of ITO, the thickness of the ITO electrode layer is about 145 nm. When the ITO electrode layer is sandwiched between two materials in which one has lower refractive index than that of ITO and the other material has higher refractive index than that of ITO, the thickness of the ITO electrode layer is about 72 nm.

The thickness of the electrode layer is only provided for illustration, but the thicknesses of the first electrode layer and the second electrode layer is not necessary a constant value and related to the refractive indices of the electrode material thereof and the materials that the electrode layer is sandwiched therebetween.

Except for the aforementioned liquid crystal panel and the method for driving the same, the present invention further provides a liquid crystal display device using the aforementioned liquid crystal panel and method. The liquid crystal display device of the present invention comprises: a light source providing an incident light; and the aforementioned liquid crystal panel disposed over the light source. In the liquid crystal display device of the present invention, the light source may be a backlight module disposed under the liquid crystal panel, i.e. at a side corresponding to the first substrate. The backlight module used in the present invention can be the same generally used in the art, so the detail description thereof is omitted herein. Preferably, the backlight module used in the liquid crystal display device of the present invention can be a backlight module which can provide collimated backlight.

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional view showing a liquid crystal panel of Embodiment 1 of the present invention after a bias voltage is provided thereto;

FIG. 2 is a perspective view showing a liquid crystal panel of Embodiment 1 of the present invention before a bias voltage is provided thereto;

FIG. 3 is a perspective view showing a liquid crystal panel of Embodiment 2 of the present invention before a bias voltage is provided thereto;

FIG. 4 is a cross-sectional view showing a liquid crystal panel of Embodiment 3 of the present invention after a bias voltage is provided thereto; FIG. 5 is a perspective view showing a second electrode layer on a second substrate of a liquid crystal panel according to Embodiment 4 of the present invention;

FIG. 6 is a perspective view showing a second electrode layer on a second substrate of a liquid crystal panel according to Embodiment 5 of the present invention; and FIG. 7 is a perspective view showing a liquid crystal display device according to Embodiment 6 of the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1

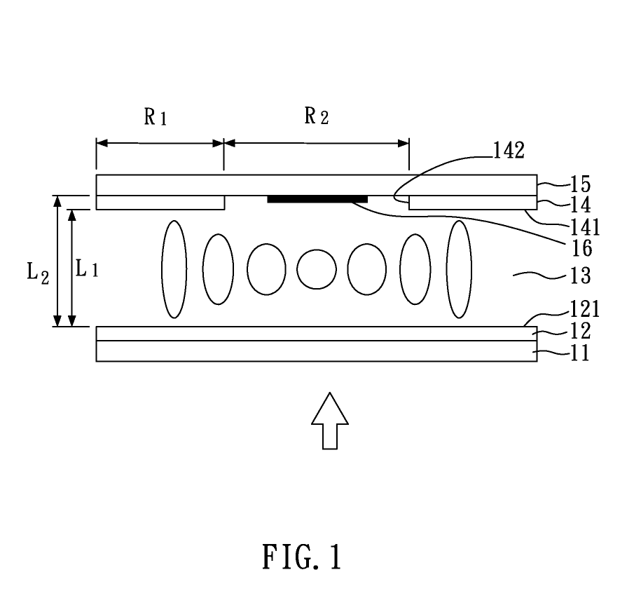

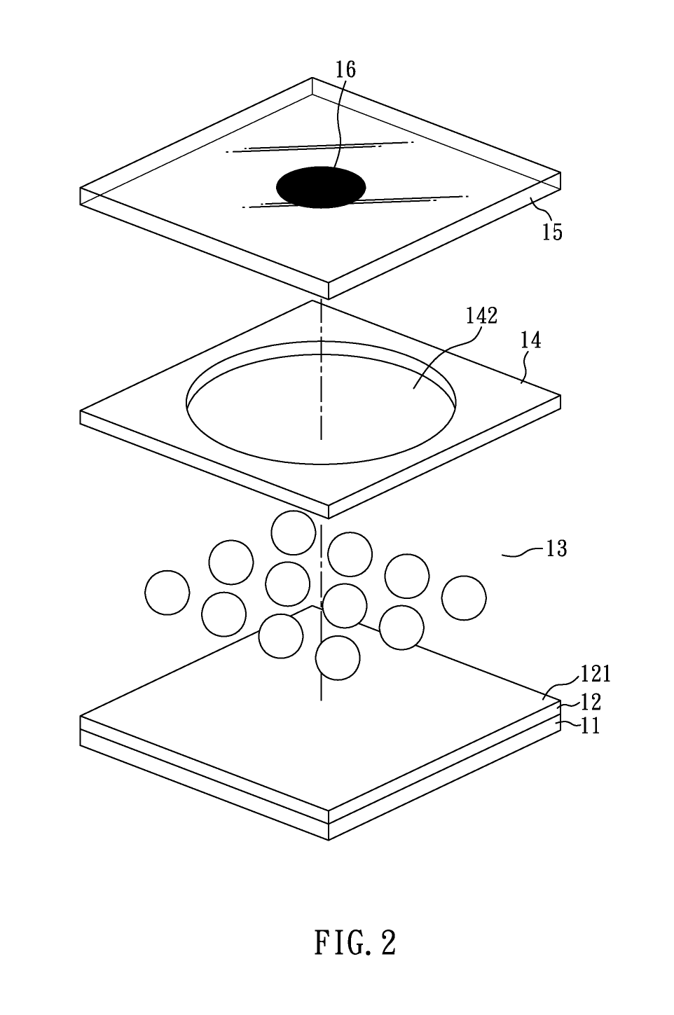

FIG. 1 is a cross-sectional view showing a liquid crystal panel of the present embodiment after a bias voltage is provided thereto, and FIG. 2 is a perspective view showing the liquid crystal panel of the present embodiment before a bias voltage is provided thereto.

As shown in FIG. 1 and FIG. 2, the liquid crystal panel of the present embodiment comprises: a first substrate 11 having a first electrode layer 12, wherein the first electrode layer 12 has a first surface 121; a second substrate 15 having a second electrode layer 14 opposite and parallel to the first electrode layer 12, the second electrode layer 14 has a second surface 141, and the second surface 141 faces to the first surface 121 of the first electrode layer 12; a blue-phase liquid crystal layer 13 comprising blue-phase liquid crystals and disposed between the first substrate 11 and the second substrate 15; and a light-shielding region 16 disposed on a surface of the second substrate 15 facing to the first electrode layer 12. Herein, a distance L₁ between the first surface 121 of the first electrode layer 12 and the second surface 141 of the second electrode layer 14 in a first region R₁ is different from a distance L₂ between the first surface 121 of the first electrode layer 12 and the second substrate 15 in a second region R₂. The first electrode layer 12 is a plate electrode; and the second electrode layer 14 is a patterned electrode layer, such as a wavy electrode, a curved electrode, a stripe electrode, or an electrode with an opening The pattern of the second electrode layer 14 is not particularly limited, as long as the distance L₁ in the first region R₁ is different from the distance L₂ in the second region R₂. Preferably, the patterned electrode layer is an electrode with an opening, and the shape of the opening is not particularly limited. Since the distances L₁ and L₂ may be differed based on the pattern of the electrode layer and the shape of the opening, it is not particularly limited to whether the first electrode layer or the second electrode layer has a uniform thickness or not. In the case that the distance between the first electrode layer 12 and the second electrode layer 14 is considered by average thicknesses thereof, different refractive indices in different regions can be obtained to meet the requirement of refractive gradient when the distances L₁ and L₂ are different. Hence, when a bias voltage is provided to the first electrode layer 12 and the second electrode 14 to form a refractive gradient in the blue-phase liquid crystal layer 13, the incident light illuminating from a side of the first substrate 11 and passing through the blue-phase liquid crystal layer 13 can focus on the light-shielding region 16. In the present embodiment, the first substrate 11 is a TFT substrate, and the second substrate 15 is a CF substrate. In addition, the light-shielding region 16 of the present embodiment is disposed in the opening 142. However, in other embodiments, for the purpose of maintaining the aperture rate of the panel, the light-shielding region 16 may be disposed outside the opening 142 such as a black matrix of the color filter. However, the position of the light-shielding region 16 is not limited to the aforementioned exemplified positions, and can be set according to the relative positions of the first region R₁ and the second region R₂ as well as the focusing position of the incident light.

In the present embodiment, both the first substrate 11 and the second substrate 15 are glass substrates, and both the first electrode layer 12 and the second electrode layer are ITO electrodes. In the present embodiment, the first electrode layer is a plate electrode, the second electrode layer 14 is a patterned electrode with a circular opening 142, and the light-shielding region 16 is disposed in the opening 142 of the second electrode layer 14 and at a position that the incident light can focus thereon after the voltage is provided to the panel. In addition, the blue-phase liquid crystal layer 13 comprises not only blue-phase liquid crystals but also a polymer for stabilizing the blue-phase liquid crystals.

As shown in FIG. 2, when there is no voltage provided to the first electrode layer 12 and the second electrode layer 14, the blue-phase liquid crystals are isotropic, the incident light passing through the blue-phase liquid crystal layer is not deflected. In this case, when an incident light illuminates from a side of the first substrate 11 (indicated as an arrow in FIG. 1) and passes through the blue-phase liquid crystal layer 13, the incident light is not deflected by the blue-phase liquid crystal and do not focus on the light-shielding region 16, so the panel is present in a bright state.

As shown in FIG. 1, when a bias voltage is provided to the first electrode layer 12 and the second electrode layer 14, a non-uniform electric field is formed due to the opening 142 of the second electrode layer 14. This non-uniform electric field can induce a refractive gradient formed in the blue-phase liquid crystal layer 13, and the blue-phase liquid crystal layer 13 with the refractive gradient can be used as a gradient refractive index lens. When the incident light illuminates from a side of the first substrate 11 (indicated as an arrow in FIG. 1) and passes through the blue-phase liquid crystal layer 13, the path thereof is deflected by the blue-phase liquid crystal layer 13 with the refractive gradient and the incident light focuses on the light-shielding region 16. In this case, the panel is present in a dark state. In the present embodiment, after the voltage is provided to the panel, the refractive index is increased from the periphery of the opening 142 to the center thereof. However, in other embodiments, the refractive index may be decreased from the periphery of the opening 142 to the center thereof if it is necessary.

Hence, in the liquid crystal panel of the present embodiment, the formed non-uniform electric field can induce the blue-phase liquid crystal layer to form a gradient refractive index lens, so as the focusing levels of incident light can be adjusted and the panel can be present in a bright or dark state as well as a grey state. Hence, compared to the conventional liquid crystal panel, the panel of the present invention does not have a polarizer, so the problem that the incident light is absorbed by the polarizer can be improved. Therefore, the utilization rate of the backlight module can further be increased.

### Embodiment 2

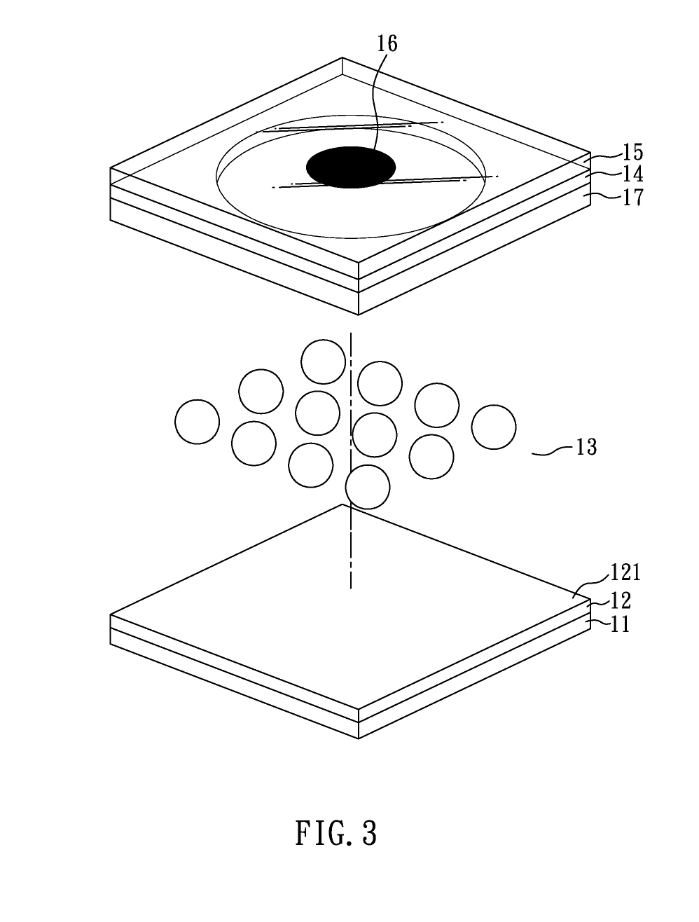

FIG. 3 is a perspective view showing a liquid crystal panel of the present embodiment before a bias voltage is provided thereto. As shown in FIG. 3, the structure of the liquid crystal panel and the method for driving the same of the present embodiment are similar to those of Embodiment 1, except that a micro-lens array 17 is disposed under the second electrode layer 14 and faces to the first electrode layer 12. The disposed micro-lens array 17 can facilitate the light, which passes through the blue-phase liquid crystal layer 13, focusing on the light-shielding region 16. In other embodiments, the micro-lens array may be disposed between the second electrode layer 14 and the second substrate 15, if it is necessary.

### Embodiment 3

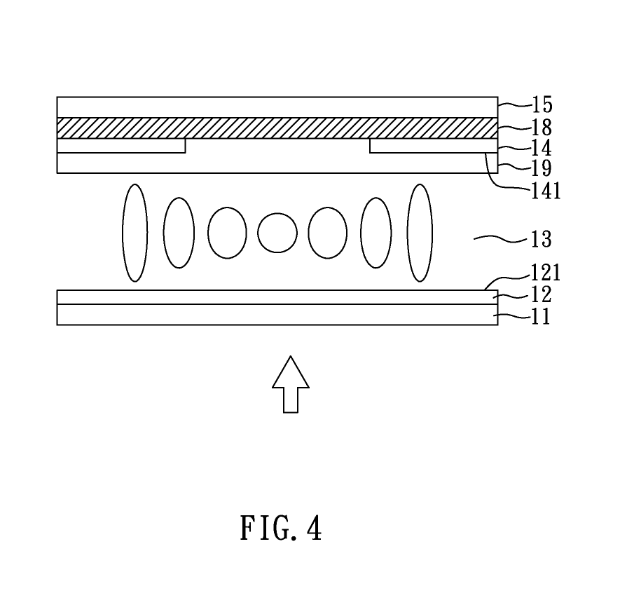

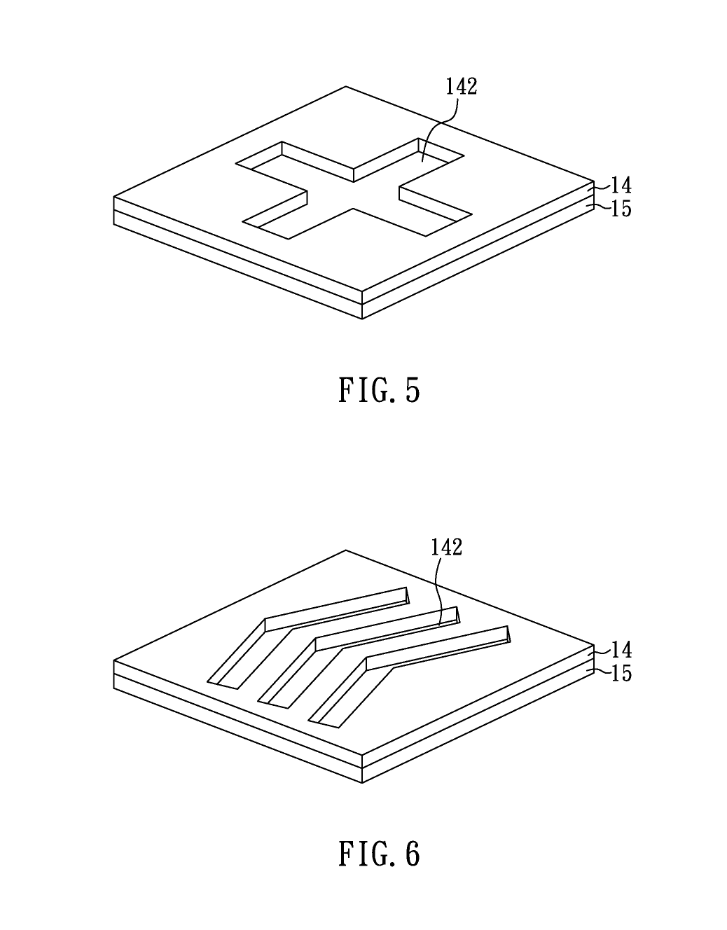

FIG. 4 is a cross-sectional view showing a liquid crystal panel of the present embodiment after a bias voltage is provided thereto. As shown in FIG. 4, the structure of the liquid crystal panel and the method for driving the same of the present embodiment are similar to those of Embodiment 1, except that a dielectric layer 19 is disposed under the second electrode layer 14 and faces to the first electrode layer 12. The disposed dielectric layer 19 can facilitate the light, which passes through the blue-phase liquid crystal layer 13, focusing on a light-shielding region (not shown in the figure). In addition, the liquid crystal panel of the present embodiment does not comprise the light-shielding region of Embodiment 1. In the present embodiment, the incident light passing through the blue-phase liquid crystal layer 13 is designed to focus on a black matrix of a color filter 18, in which the black matrix can absorb the focusing light.

### Embodiment 4

FIG. 5 is a perspective view showing a second electrode layer on a second substrate of a liquid crystal panel of the present embodiment. Since the structure of the liquid crystal panel and the method for driving the same of the present embodiment are similar to those of Embodiment 1, FIG. 5 only shows the different portion between the present embodiment and Embodiment 1. As shown in FIG. 5, the opening 142 of the second electrode layer 14 on the second substrate 15 of the present embodiment has a cross shape. Herein, a light-shielding region (not shown in the figure) can be disposed in the opening 142. In other embodiments, the light-shielding region may be disposed outside the opening 142 of the second electrode layer 14 or the periphery of the electrode layer; and in this case, the aperture rate of the panel can be maintained.

### Embodiment 5

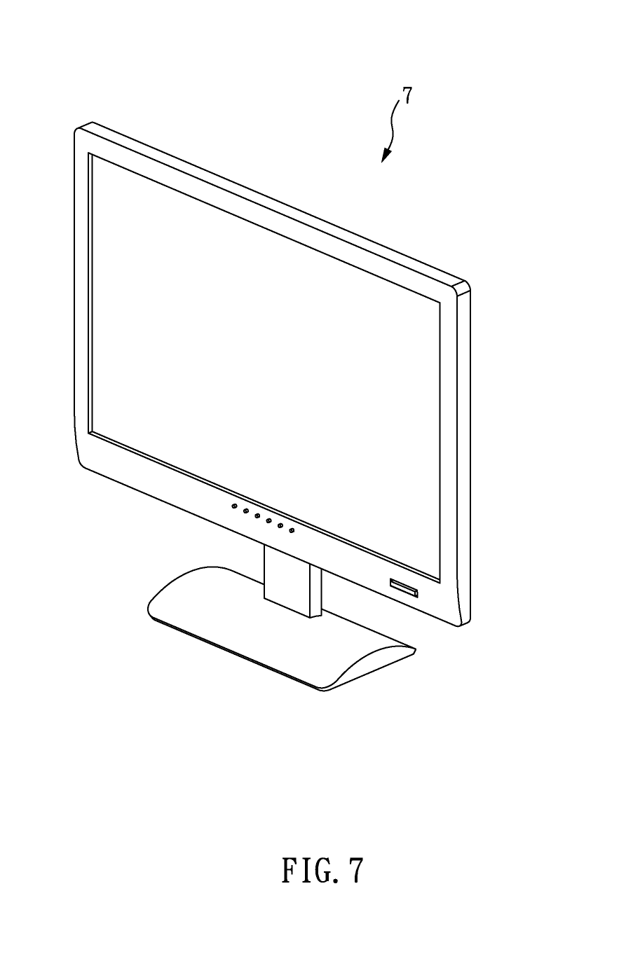

FIG. 6 is a perspective view showing a second electrode layer on a second substrate of a liquid crystal panel of the present embodiment. Since the structure of the liquid crystal panel and the method for driving the same of the present embodiment are similar to those of Embodiment 1, FIG. 6 only shows the different portion between the present embodiment and Embodiment 1. As shown in FIG. 6, the opening 142 of the second electrode layer 14 on the second substrate 15 of the present embodiment has a chevron or boomerang shape. Herein, a light-shielding region (not shown in the figure) can be disposed in the opening 142. In other embodiments, the light-shielding region may be disposed outside the opening 142 or the periphery of the electrode layer; and in this case, the aperture rate of the panel can be maintained.

### Embodiment 6

FIG. 7 is a perspective view showing a liquid crystal display device of the present embodiment, which comprises any one of the aforementioned liquid crystal panels; and a light source providing an incident light (not shown in the figure), wherein the light source is disposed under the liquid crystal panel.

Although the present invention has been explained in relation to its preferred embodiment, it is to be understood that many other possible modifications and variations can be made without departing from the spirit and scope of the invention as hereinafter claimed.

What is claimed is:

1. A liquid crystal panel, comprising:
a first substrate having a first electrode layer;
a second substrate having a second electrode layer opposite to the first electrode layer;
a blue-phase liquid crystal layer disposed between the first substrate and the second substrate; and
a light-shielding region disposed on the second substrate,
wherein a bias voltage is provided to the first electrode layer and the second electrode layer to form a refractive gradient in the blue-phase liquid crystal layer, and an incident light passing through the blue-phase liquid crystal layer with the refractive gradient focuses on the light-shielding region.

2. The liquid crystal panel as claimed in claim 1, wherein the first electrode layer is a plate electrode, and the second electrode layer is a patterned electrode.

3. The liquid crystal panel as claimed in claim 2, wherein the second electrode layer has an opening

4. The liquid crystal panel as claimed in claim 3, wherein the light-shielding region is disposed on the second substrate and in the opening of the second electrode layer.

5. The liquid crystal panel as claimed in claim 2, wherein the light-shielding region is a black matrix disposed outside the opening of the second electrode layer.

6. The liquid crystal panel as claimed in claim 1, wherein the light-shielding region is a light-absorbing layer or a reflection layer.

7. The liquid crystal panel as claimed in claim 1, further comprising a dielectric layer or a micro-lens array, which is disposed on the second electrode layer.

8. The liquid crystal panel as claimed in claim 1, wherein when the first electrode layer or the second electrode layer is sandwiched between two materials, in which both materials have lower or higher refractive indices than that of an electrode material of the first electrode layer or the second electrode layer, a thickness of the first electrode layer or the second electrode layer is satisfied with the following equation (I):
Thickness=(a wavelength of the incident light)/(2×the refractive index of the electrode material) (I).

9. The liquid crystal panel as claimed in claim 1, wherein when the first electrode layer or the second electrode layer is sandwiched between a first material and a second material, in which the first material has a lower refractive index than that of an electrode material of the first electrode layer or the second electrode layer and the second material has a higher refractive index than that of the electrode material of the first electrode layer or the second electrode layer, a thickness of the first electrode layer or the second electrode layer is satisfied with the following equation (II):
Thickness=(a wavelength of the incident light)/(4×the refractive index of the electrode material) (II).

10. A method for driving a liquid crystal panel, comprising the following steps:
(A) providing a liquid crystal panel, which comprises:
a first substrate having a first electrode layer;
a second substrate having a second electrode layer opposite to the first electrode layer;
a blue-phase liquid crystal layer disposed between the first substrate and the second substrate; and
a light-shielding region disposed on the second substrate; and
(B) providing a bias voltage to the first electrode layer and the second electrode layer to form a refractive gradient in the blue-phase liquid crystal layer, in which an incident light passing through the blue-phase liquid crystal layer with the refractive gradient focuses on the light-shielding region.

11. The method as claimed in claim 10, wherein the first electrode layer is a plate electrode, and the second electrode layer is a patterned electrode.

12. The method as claimed in claim 11, wherein the second electrode layer has an opening

13. The method as claimed in claim 12, wherein the light-shielding region is disposed on the second substrate and in the opening of the second electrode layer.

14. The method as claimed in claim 12, wherein the light-shielding region is a black matrix disposed outside the opening of the second electrode layer.

15. The method as claimed in claim 10, wherein the light-shielding region is a light-absorbing layer or a reflection layer.

16. The method as claimed in claim 10, wherein the liquid crystal panel further comprises: a dielectric layer or a micro-lens array, which is disposed on the second electrode layer.

17. The method as claimed in claim 10, wherein when the first electrode layer or the second electrode layer is sandwiched between two materials, in which both materials have lower or higher refractive indices than that of an electrode material of the first electrode layer or the second electrode layer, a thickness of the first electrode layer or the second electrode layer is satisfied with the following equation (I):
Thickness=(a wavelength of the incident light)/(2×the refractive index of the electrode material) (I).

18. The method as claimed in claim 10, wherein when the first electrode layer or the second electrode layer is sandwiched between a first material and a second material, in which the first material has a lower refractive index than that of an electrode material of the first electrode layer or the second electrode layer and the second material has a higher refractive index than that of the electrode material of the first electrode layer or the second electrode layer, a thickness of the first electrode layer or the second electrode layer is satisfied with the following equation (II):
Thickness=(a wavelength of the incident light)/(4×the refractive index of the electrode material) (II).

19. A liquid crystal display device, comprising:
a light source providing an incident light; and
a liquid crystal panel disposed over the light source, comprising:
a first substrate having a first electrode layer;
a second substrate having a second electrode layer opposite to the first electrode layer;
a blue-phase liquid crystal layer disposed between the first substrate and the second substrate; and
a light-shielding region disposed on the second substrate,
wherein a bias voltage is provided to the first electrode layer and the second electrode layer to form a refractive gradient in the blue-phase liquid crystal layer, and the incident light passing through the blue-phase liquid crystal layer with the refractive gradient focuses on the light-shielding region.

20. The liquid crystal display device as claimed in claim 19, wherein the second electrode layer has an opening.
